(19) United States
(12) Patent Application Publication
(10) Pub. No.: US 2018/0060770 A1
(43) Pub. Date: Mar. 1, 2018

(54) News Delivery in Enterprise Setting

(71) Applicant: Microsoft Technology Licensing, LLC, Redmond, WA (US)

(72) Inventors: Dmitriy Meyerzon, Bellevue, WA (US); Yauhen Shnitko, Sammamish, WA (US)

(73) Assignee: Microsoft Technology Licensing, LLC, Redmond, WA (US)

(21) Appl. No.: 15/444,331

(22) Filed: Feb. 28, 2017

Related U.S. Application Data
(60) Provisional application No. 62/382,767, filed on Sep. 1, 2016.

(51) Int. Cl. G06Q 10/06; H04L 12/58

(52) U.S. Cl. CPC G06Q 10/0631; H04L 51/046

(57) ABSTRACT

In one example, an enterprise news service may leverage knowledge of existing collaborative relationships between workers to pre-populate news sources for the news feed of a worker. The enterprise news service may determine an enterprise relationship describing a relationship within an enterprise between a worker and a colleague. The enterprise news service may associate the colleague with a news source set based on the enterprise relationship. The enterprise news service may receive a news item from the colleague. The enterprise news service may post the news item to a news feed of the worker based on the enterprise relationship.

### PRIORITY INFORMATION

This application claims priority from U.S. Provisional Patent Application Ser. No. 62/382,767, filed Sep. 1, 2016, the contents of which are incorporated herein by reference in its entirety.

### BACKGROUND

A user may subscribe to a social network to receive postings from a variety of sources. The social network may be a closed network, so that a target user may read a posting just from a source user with whom the target user has a pre-established relationship. Alternately, the social network may be an open network, in that any user may read the post of any other user. In the open network, the target user may select specific source users whose postings the social network collects into a feed for the target user. The relationship between a target user and a source user may be unilateral, so that just the request from the target user establishes the relationship with the source user. Alternately, the relationship between a target user and a source user may be bilateral, in that the source user may confirm the request from the target user before establishing the relationship.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Examples discussed below relate to leveraging knowledge of existing enterprise relationships between workers to pre-populate news sources for the news feed of a worker. The enterprise news service may determine an enterprise relationship describing a relationship within an enterprise between a worker and a colleague. The enterprise news service may associate the colleague with a news source set based on the enterprise relationship. The enterprise news service may receive a news item from the colleague. The enterprise news service may post the news item to a news feed of the worker based on the enterprise relationship.

### DRAWINGS

In order to describe the manner in which the above-recited and other advantages and features can be obtained, a more particular description is set forth and will be rendered by reference to specific examples thereof which are illustrated in the appended drawings. Understanding that these drawings depict only typical examples and are not therefore to be considered to be limiting of its scope, implementations will be described and explained with additional specificity and detail through the use of the accompanying drawings.

FIG. 1 illustrates, in a block diagram, one example of an enterprise network.

FIG. 2 illustrates, in a block diagram, one example of a computing device.

FIG. 3 illustrates, in a block diagram, one example of an office graph.

FIG. 4 illustrates, in a flowchart, one example of a method for establishing an office graph with a corporate server.

FIG. 5 illustrates, in a block diagram, one example of a software architecture for a news aggregator.

FIG. 6 illustrates, in a block diagram, one example of worker profile.

FIG. 7 illustrates, in a block diagram, one example of a user interface for a news reader.

FIG. 8 illustrates, in a flowchart, one example of a method for creating a news source set with an enterprise news service.

FIG. 9 illustrates, in a flowchart, one example of a method for confirming a news source set with a news reader.

FIG. 10 illustrates, in a flowchart, one example of a method for updating a news source set based on a collaboration site.

FIG. 11 illustrates, in a flowchart, one example of a method for publishing a news item from a worker.

FIG. 12 illustrates, in a flowchart, one example of a method for receiving a news item at an enterprise news service.

FIG. 13 illustrates, in a flowchart, one example of a method for broadcasting a news item at an enterprise news service.

FIG. 14 illustrates, in a flowchart, one example of a method for receiving a news item in a news reader.

FIG. 15 illustrates, in a flowchart, one example of a method for arranging a news item in a news feed at a news reader.

FIG. 16 illustrates, in a flowchart, one example of a method 1500 for processing a news item a news reader.

### DETAILED DESCRIPTION

Examples are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be an enterprise news service, a computing device, or a machine-implemented method.

In one example, an enterprise news service may leverage knowledge of existing enterprise relationships between workers to pre-populate news sources for a news feed of a worker. The enterprise news service may determine an enterprise relationship describing a relationship within an enterprise between a worker and a colleague. The enterprise news service may associate the colleague with a news source set based on the enterprise relationship. The enterprise news service may receive a news item from the colleague. The enterprise news service may post the news item to a news feed of the worker based on the enterprise relationship.

In an enterprise setting, organizational leaders may use an enterprise news service to share plans and status updates with the organization and related employees. The enterprise news service may be organized similar to traditional social media, such as Facebook®, Twitter®, or Tumblr®, that has a user select the news sources to follow. However, in the enterprise setting, the news service may leverage inherent knowledge of corporate structure and connections between workers to identify colleagues that the worker may benefit from following without having to first have the worker explicitly follow a given source. For purposes of this enterprise news service, a worker may refer to an employee, a contractor, or some other person affiliated with an enterprise. A colleague may refer to another member of the enterprise, such as a collaborator working with the worker on a project, a manager of the worker, or a collaborator manager overseeing the collaborator.

Thus, while traditional social media may suffer from a problem of bootstrapping the service to achieve a critical mass of people subscribing to news topics or sources, the enterprise news service may automatically bootstrap the system based on an enterprise relationship between employees, such as organizational relations or collaborative relationships. The enterprise news server may use the type of enterprise relationship between a worker and a colleague to determine whether the colleague is to be a news source for the worker. An enterprise relationship describes the relationship between the worker and the colleague for purposes of the enterprise. The collaborative relationship may be time dependent, so that older collaborative relationships may age out without indications of current interactions. The enterprise relationship may be a directly interactive relationship, such as a collaborative relationship between the worker and a collaborator on a work project or a hierarchical relationship between a worker and a manager. A relevant enterprise relationship may also be an indirectly interactive relationship, such as a relationship with a collaborator manager overseeing a collaborator in a collaborative relationship with a worker.

An employee may author a news item announcing an event or a status update. Further, an organizational leader may share a project vision with the employees. The upper management may publicize a company-wide events or share a public news item. In addition, an employee may post about a news item on the internet relevant to a particular company matter. The internal news item may be a short text having a reference to an internal or external article or a tag with a certain topic. A news item may be a simplified modern publishing page created with metadata identifying the item as news. The news item may contain a reference to a document, such as an external link. The reference document may be an internal document or a news article on the internet.

In the enterprise setting, an enterprise news service may have much more information about relations between employees, such as reporting structure and collaboration efforts. By leveraging this information, a worker may not have to explicitly follow others to get any news. Instead, the enterprise news service may generate an office graph to compute collaborative relationships between people in the company and organizational hierarchy. For example, the office graph may link workers who frequently email each other, attend the same meetings, or co-author documents.

Employees may create a small number of news items each day, but for a potentially large audience. News may be time sensitive, thus the news server may post news items to appear in all the target news feeds within 1-2 hours. Additionally, a collaboration site, such as a project site or a team site, may have a collection of news presented in chronological order as a collaboration site news channel.

The enterprise news service may aggregate news items from across the company into a personalized newsfeed for each worker. An application on the workstation or a mobile application on a smart phone may surface the newsfeed to the worker. The personalized newsfeed may contain ranked news items across different collaboration sites. The news service may rank the individual news items in the news feed based on a number of criteria, such as the status of the authors, the timing of the posting of the news item, the popularity of the news item based on user interactions, or a user preference for the topic of the news item, whether explicit or implicit. Additionally, the worker may query the entire corpus of the enterprise news items based on time, author, team, or subject.

At query time, the enterprise news service may retrieve a list of news sources for the worker. The enterprise news service may query an office graph for news items created by those news sources. The news sources may be colleagues of the workers or collaboration sites subject to frequent interaction with the worker. The news sources may also be collaboration sites subject to frequent interaction with the colleagues of the worker.

The office graph may treat modern pages, including news items, as any other documents. When a worker publishes a news item, the office graph may represent the action with a modified edge between a node representing the worker and a node representing the news item. In order for the target worker to receive the news item efficiently, the enterprise news service may materialize an edge between a worker and a colleague representing a relevant news source for that worker. Alternately, the enterprise news service may infer the news edge that connects each user receiving the news post in their newsfeed with the news item. The office graph may approximate the organizational structure in the company as a tree, with the total number of news sources the same order of magnitude as related people.

In order to materialize edges for the news feed, the office graph may produce a set of news subscription edges in a single push-out analytic to map each worker to a set of colleagues acting as a news source. Additionally, the enterprise news service may subscribe the worker to a news feed from a collaboration site, whether one visited by the worker or by a colleague of sufficient intersecting interests. Since the enterprise news service may provide news from each related person and up the management chain, the office graph may execute a multi-hop transitive closure of the manager links out to related people and up the hierarchy for the depth of the reporting hierarchy in the company. Posting news may generate a “news” signal from the enterprise news service having the uniform resource locator of the post, the author, the time, and the site where the news item was published. In order for the news items to appear in analytics faster than the frequency of the link store input analysis, the enterprise news service may add uniform resource locators to the news signals to support link store lookup optimization.

Alternately to a news service, the enterprise may implement a mailbox based architecture. For ordinary least squares regression, the news feed may materialize a secondary shallow copy of the news item for each worker subscribing to the corresponding news source. Assuming a manager mailbox for a worker is already a news source, the enterprise news service may trickle the news item down to each subscriber one level at a time recursively via reactive analytics. The news channel of a collaboration site may omit subscriptions because the user may access the corresponding news feed at query fan out.

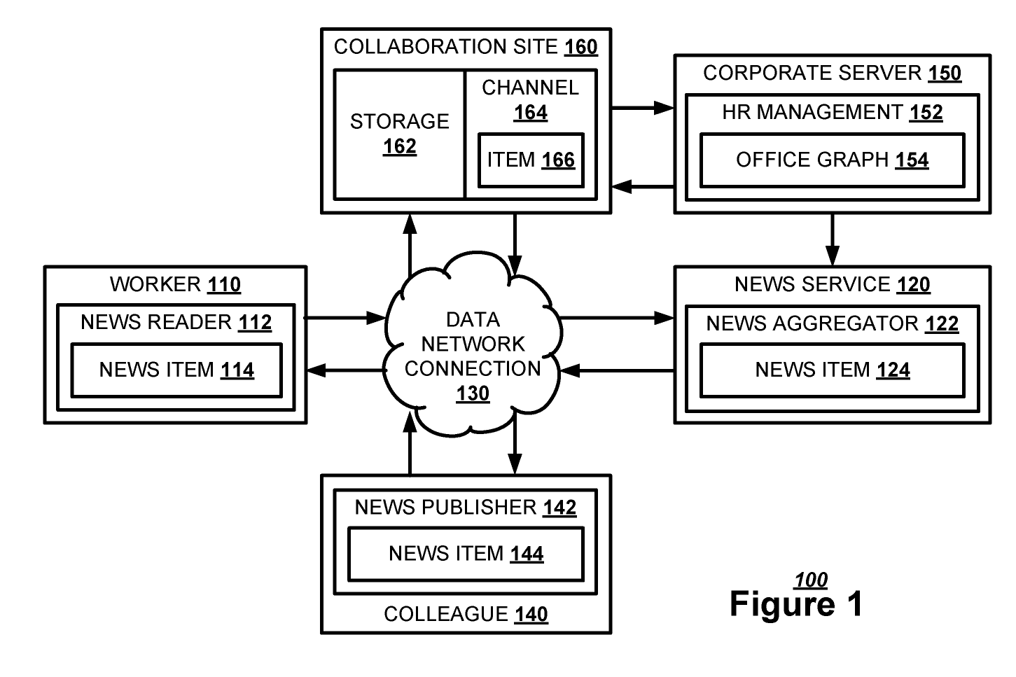

FIG. 1 illustrates, in a block diagram, one example of an enterprise network 100. A worker device 110 used by a worker may implement a news reader module 112 to read a news item 114 downloaded from an enterprise news service 120 via a data network connection 130. The worker device 110 may be a desktop computer, a workstation, a smart phone, a tablet, a smart watch, or other computing device capable of executing a news reader module 112. The enterprise news service 120 may be hosted on a server or server farm. The enterprise news service 120 may execute a news aggregator 122 to host news items 124 published from a variety of news sources. The enterprise news service 120 may provide the news items 124 from a news source set associated with the worker to the worker device 110 as part of a news feed. For certain high value news items, the enterprise news service 120 may push the individual news items 124 to the worker device 110 without a download request from the worker. The data network connection 130 may be an enterprise network connection, an internet connection, a wide area network connection, a local area network connection, a mobile telephone network, or other type of data network connection.

A colleague associated with the worker may use a colleague device 140 executing a news publisher module 142 to post a news item 144 to the enterprise news service 120 via the data network connection 130. The news reader module 112 and the news publisher module 114 may be part of the same application. The worker may select certain colleagues to be part of the news source set. To aid in the populating of the news source set for the worker, the enterprise news service 120 may contact a corporate administrative server 150 to access a human resource management database 152 for an office graph 154. An office graph 154 may identify colleagues having an enterprise relationship with the worker, such as a collaborator working on a project with the worker, a manager overseeing the worker, or a collaborator manager overseeing the collaborator. Further, the office graph 154 may describe the specific collaborative relationship between the worker and the collaborators, such as fellow team members, workers assigned to the same project, frequent email correspondents, meeting attendees, document co-authors, and other commonalities.

Additionally, a worker may collaborate on a project with a collaborator using a collaboration site 160. The collaboration site 160 may provide a network storage 162 that the worker and the colleague may use to share work product and information about the project. A collaboration site 160 may be assigned to a single project or may be used for multiple projects. Further, the collaboration site may host a news channel 164 to present news items 166 about a project, such as news items 166 posted by a worker or a colleague. Additionally, the news channel 164 may store an archive of relevant news items posted by associated workers. The collaboration site 160 may pass these news items to the enterprise news service for publication to a worker that interacts with the collaboration site 160 above a threshold number of times. The enterprise news service 120 may also add the collaboration site 160 to the news source set. Further, the enterprise news service 120 may add a colleague accessing the collaboration site 160 above a threshold number of times to the news source set for the worker.

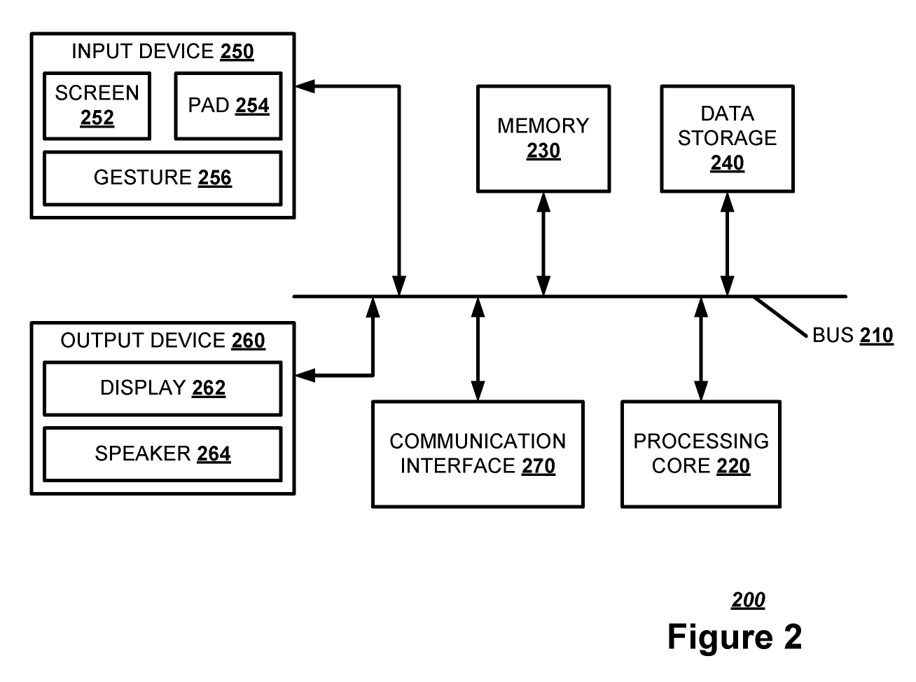

FIG. 2 illustrates a block diagram of an exemplary computing device 200 which may act as a target user, a source user, or an enterprise news service. The computing device 200 may combine one or more of hardware, software, firmware, and system-on-a-chip technology to implement a news reader, a news publisher, or a news aggregator. The computing device 200 may include a bus 210, a processing core 220, a memory 230, a data storage 240, an input device 250, an output device 260, and a communication interface 270. The bus 210, or other component interconnection, may permit communication among the components of the computing device 200.

The processing core 220 may include at least one conventional processor or microprocessor that interprets and executes a set of instructions. The processing core 220 may be configured to determine an enterprise relationship describing a relationship within an enterprise between a worker and a colleague. The processing core 220 may be further configured to assign a source rating describing an interaction rate with the news source to a news item authored by a colleague based on the enterprise relationship of the colleague. The processing core 220 may also be configured to adjust the source rating for a collaborator manager based on a quantity of collaborators reporting to the collaborator manager. The processing core 220 may be additionally configured to categorize a subject matter for the news item. The processing core 220 may be further configured to assign a subject rating describing an interaction rate with the subject to the news item based on a subject matter of the news item. The processing core 220 may be also configured to assign a relevancy rating describing an expected degree of interaction to a set of news items based on at least one of a source rating and a subject rating. The processing core 220 may be additionally configured to compare a relevancy rating of the news item to a relevancy threshold. The processing core 220 may be further configured to adjust a worker profile describing a worker news preference based on an interaction of the worker with the news item.

The memory 230 may be a random access memory (RAM) or another type of dynamic data storage that stores information and instructions for execution by the processing core 220. The memory 230 may also store temporary variables or other intermediate information used during execution of instructions by the processing core 220. The memory 230 may be configured to associate the colleague with a news source set based on the enterprise relationship. The memory 230 may be further configured to identify the enterprise relationship as at least one of a manager, a collaborator, and a collaborator manager. The memory 230 may be additionally configured to maintain a worker profile describing a worker news preference based on the enterprise relationship. The memory 230 may be also configured to associate a collaboration site with the news source set for the worker based on a site visit by the worker.

The data storage 240 may include a conventional ROM device or another type of static data storage that stores static information and instructions for the processing core 220. The data storage 240 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 240 may store a set of instructions detailing a method that when executed by one or more processors cause the one or more processors to perform the method. The data storage 240 may also be a database or a database interface for storing news items, news source sets, or worker profiles.

The input device 250 may include one or more conventional mechanisms that permit a user to input information to the computing device 200, such as a keyboard, a mouse, a voice recognition device, a microphone, a headset, a touch screen 252, a touch pad 254, a gesture recognition device 256, etc. The output device 260 may include one or more conventional mechanisms that output information to the user, including a display screen 262, a printer, one or more speakers 264, a headset, a vibrator, or a medium, such as a memory, or a magnetic or optical disk and a corresponding disk drive.

The communication interface 270 may include any transceiver-like mechanism that enables computing device 200 to communicate with other devices or networks. The communication interface 270 may include a network interface or a transceiver interface. The communication interface 270 may be a wireless, wired, or optical interface. The communication interface 270 may be configured to receive a news item from the colleague. The communication interface 270 may be further configured to post the news item to a news feed of the worker based on the enterprise relationship. The communication interface 270 may be also configured to push the news item to the worker when a relevancy rating of the new item is greater than a push threshold. The communication interface 270 may be additionally configured to receive a user input to remove the colleague from the news source set. The communication interface 270 may be further configured to receive a user input to add a news source to the news source set. The communication interface 270 may be also configured to receive a visit notification from a collaboration site indicating a visit by the worker.

The computing device 200 may perform such functions in response to processing core 220 executing sequences of instructions contained in a computer-readable medium, such as, for example, the memory 230, a magnetic disk, or an optical disk. Such instructions may be read into the memory 230 from another computer-readable medium, such as the data storage 240, or from a separate device via the communication interface 260.

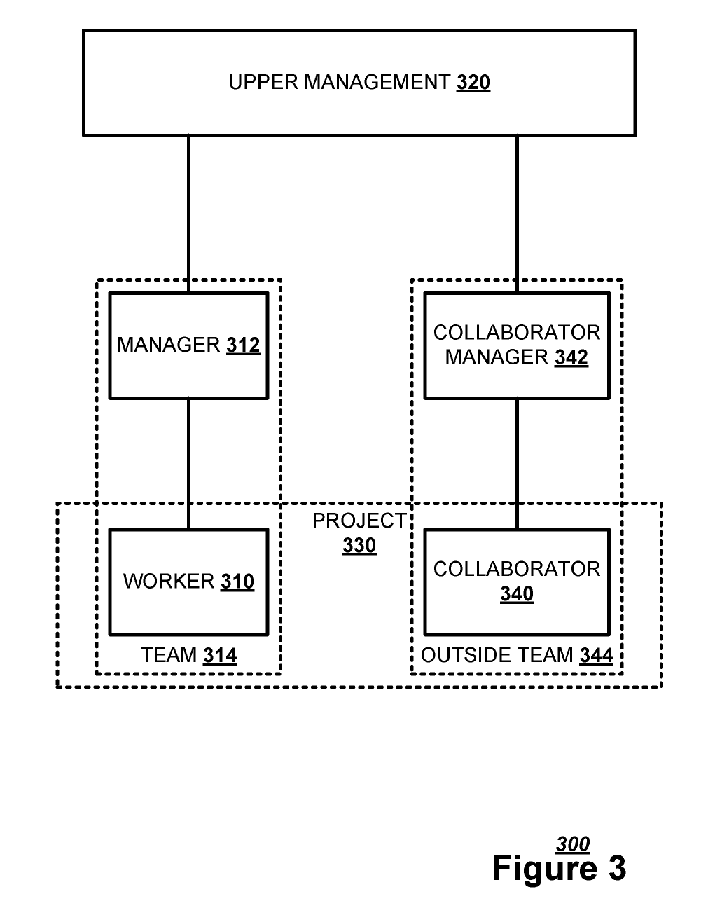

FIG. 3 illustrates, in a block diagram, one example of an office graph 300. An office graph 300 may describe enterprise relationships between various workers participating in an enterprise setting. The office graph 300 may connect a worker 310 to a manager 312, indicating a manger overseeing the worker 310 either directly or indirectly. The other workers overseen by the manager 312 as well as the manager 312 may compose a corporate team 314. As news items published by a team member may be of importance to a worker 310, the enterprise news service may designate one or more members of the corporate team 314 as a news source for the worker 310. Additionally, various levels of upper management 320 may oversee the manager 312, such as directors or even a chief executive officer. As news items published by a member of upper management 320 may be of importance to a worker 310, the enterprise news service may designate one or more members of upper management 320 as a news source for the worker 310.

A worker 310 may be working on a project 330 with a collaborator 340 who is not a member of the corporate team 314 of the worker 310. As news items published by a collaborator 340 may be of importance to a worker 310, the enterprise news service may designate the collaborator 340 as a news source for the worker 310. The more projects 330 the collaborator 340 is working on with the worker 310, the more likely that a news item published by the collaborator 340 is to be relevant. A collaborator manager 342 may oversee the collaborator 340. The other workers overseen by the collaborator manager 342 as well as the collaborator manager 342 may compose an outside team 344. As news items published by a member of the outside team 344 may be of importance to a worker 310, the enterprise news service may designate one or more members of the outside team 344 as a news source for the worker 310. The more members of the outside team 344 that are collaborators 340 with the worker 310, the more importance the enterprise news service may give to news items published by the collaborator manager 342.

Beyond projects, the enterprise news service may leverage an enterprise communication system to identify candidates for the news source set. An enterprise communication system may encompass email, chat, video conferencing, or even telephone. A news item posted by a correspondent with the worker may be of value to the worker. The greater the communication between the correspondent and the worker, the more likely that a news item may be of value to the worker. The enterprise communication system may suitably anonymize the communication data to protect worker privacy.

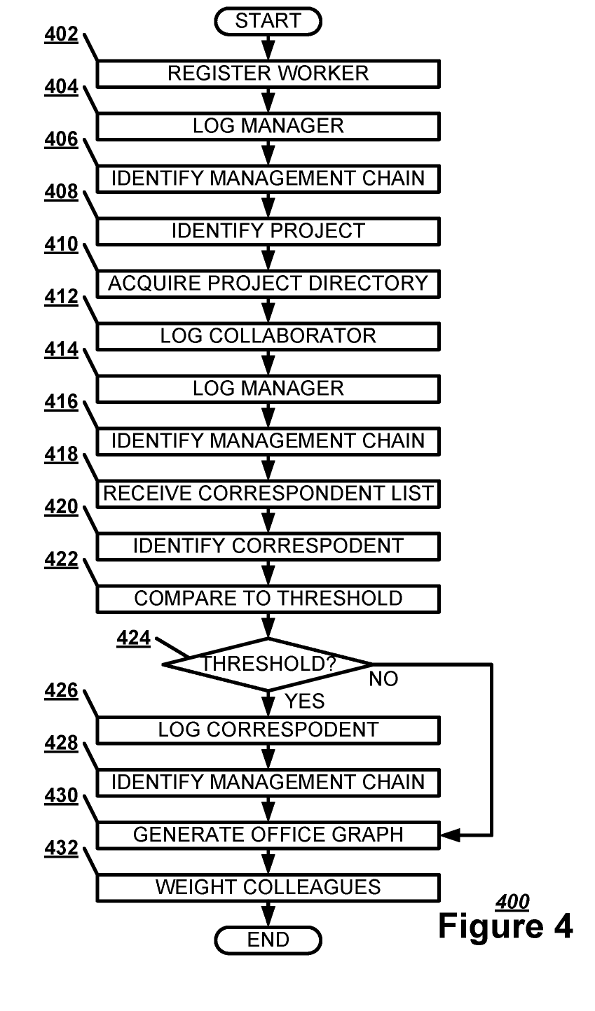

FIG. 4 illustrates, in a flowchart, one example of a method 400 for establishing an office graph for a worker with a corporate administration server. The corporate administration server may register a worker as being a part of the enterprise environment (Block 402). The corporate administration server may log a manager for the worker (Block 404). The corporate administration server may identify a management chain for the worker by performing a transitive closure of the manager (Block 406).

The corporate administration server may identify any projects assigned to the worker (Block 408). The corporate administration server may acquire a project directory for a project of the worker, possibly from a collaboration site assigned to the project (Block 410). The corporate administration server may log a collaborator on the project (Block 412). The corporate administration server may log a manager for the collaborator as a collaborator manager (Block 414). The corporate administration server may identify a management chain for the collaborator by performing a transitive closure of the collaborative manager (Block 416).

The corporate administration server may receive a correspondent list for the worker from the enterprise communication system (Block 418). The corporate administration server may identify a correspondent on the correspondent list (Block 420). The corporate administration server may compare the number of communications within a set period of time to a collaboration threshold (Block 422). If the number of communications is greater than the collaboration threshold (Block 424), the corporate administration server may log the correspondent (Block 426). The corporate administration server may log a manager for the correspondent and identify the management chain for the correspondent (Block 428).

The corporate administration server may generate an office graph representing the relationships of the worker with the logged colleagues within the enterprise (Block 430). The corporate administration server may weight colleagues on the office graph based on the enterprise relationship (Block 432). For example, the corporate administration server may assign a direct manager a first weight, a collaborator a second weight, and a collaborator manager a third weight. The corporate administration server may adjust the weight assigned to the collaborator manager based on the number of collaborators the manager oversees. The corporate administrator server may adjust the weight assigned to a colleague based on the number of communications with that colleague within a set period of time.

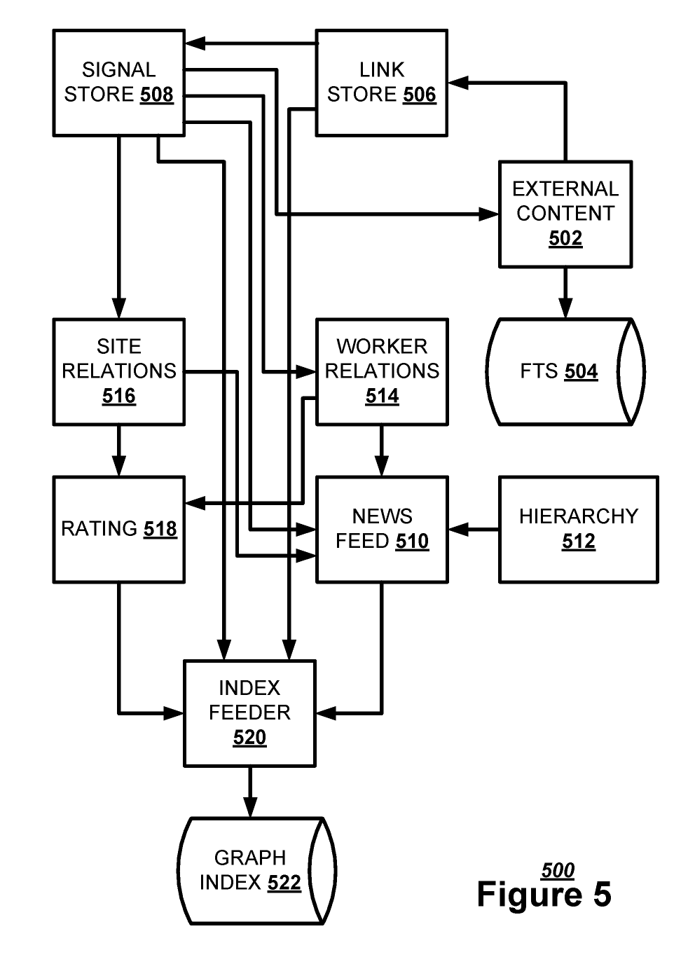

FIG. 5 illustrates, in a block diagram, one example of a software architecture 500 for a news aggregator. The news aggregator may have an external content module 502 that identifies an external news item. The news aggregator may have a full text search (FTS) module 504 to provide users with a search capability to query for documents and news articles. The external content module 502 may provide the identified item to a link store module 506 to generate a mapping between the uniform resource locator of the item and a document identifier used to reference documents. The signal store module 508 may store metadata regarding the news item, such as publishing time, author, site, or uniform resource locator.

A news feed 510 may factor various enterprise information to identify recipients of the news items and to properly rank the news items on the basis of relevancy. The news feed 510 may receive a hierarchy 512 describing the reporting structure for various employees of the enterprise. The news feed 510 may factor in data describing worker relations 514 to identify collaborators within the enterprise not identified within the reporting structure. The news feed 510 may factor in data describing site relations 516 between various collaboration sites.

A ratings module 518 may factor in the data regarding worker relations 514 and site relations 516 into determining the popularity of a news items with various workers and collaboration sites. A graph index feeder module 520 may use input form the ratings module 518 in conjunction with the news feed 510 to generate a graph index 522 describing a news feed order for a user. The news feed order may then be presented to a worker upon request.

Alternately, the ratings module 518 may rank a news item at query time without materializing the news feed 510 in the office graph. The ratings module 518 instead may materialize the relationships between a worker and a news source, such as a collaborator, a manager, a collaborator manager, or a collaboration site. At query time, the ratings module 518 may provide a ranked list of news items. The news aggregator may then provide the news items.

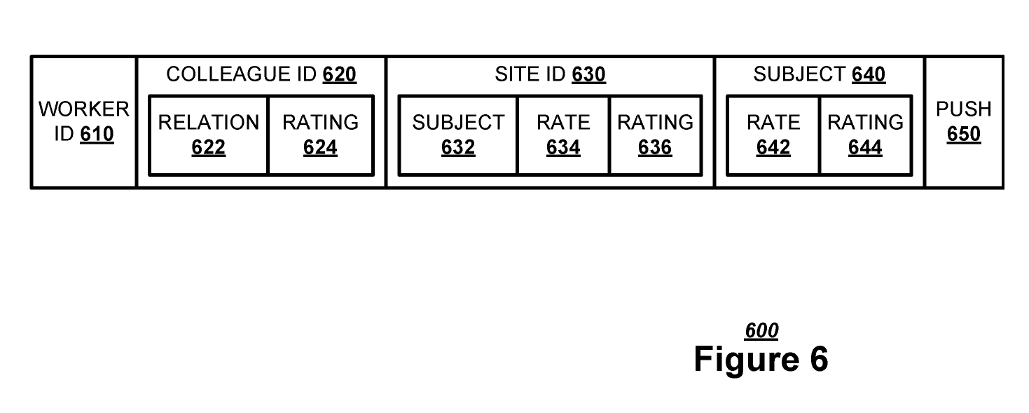

Further, the news reader module or the news aggregator may use a worker profile to determine a relevancy rating for a specific news item to determine the presentation order for that news item. FIG. 6 illustrates, in a block diagram, one example of worker profile 600. The worker profile 600 may have a worker identifier 610 indicating the worker the worker profile 600 is describing. The worker profile 600 may have one or more colleague identifiers 620 indicating colleagues that have been added to the news source set for the worker. The colleague identifier 620 may be associated with an enterprise relationship field 622 describing the relationship within the enterprise between the worker and the colleague, such as whether the colleague is a manager, a collaborator on a work project, or a collaborator manager overseeing the collaborator. The colleague identifier 620 may be associated with a relevancy rating field 624 describing a general relevancy of news items from the colleague initially based on the enterprise relationship.

The worker profile 600 may have one or more site identifiers 630 indicating collaboration sites that have been added to the news source set for the worker. The site identifiers 630 may be associated with a subject field 632 describing the project associated with the collaboration site. The site identifiers 630 may be associated with an interaction rate field 634 describing the number of visits to the collaboration site by the worker over a recent period. As the interaction rate counts visits over a recent period of time, the worker profile 600 may age out a collaboration site visited historically but not recently. The site identifiers 630 may be associated with a relevancy rating field 636 describing a general relevancy of news items based on the project associated with the collaboration site.

The worker profile 600 may have one or more subject identifiers 640 indicating a subject matter of a news item with which the worker has interacted. The subject identifiers 640 may be associated with an interaction rate field 642 describing the number of interactions with a news item concerning the subject over a recent period. The subject identifiers 640 may be associated with a relevancy rating field 644 describing a general relevancy of news items based on the subject. The worker profile 600 may have a push threshold 650 describing a relevancy rating that may indicate the news item is to be pushed to the worker, rather than waiting for a news feed request.

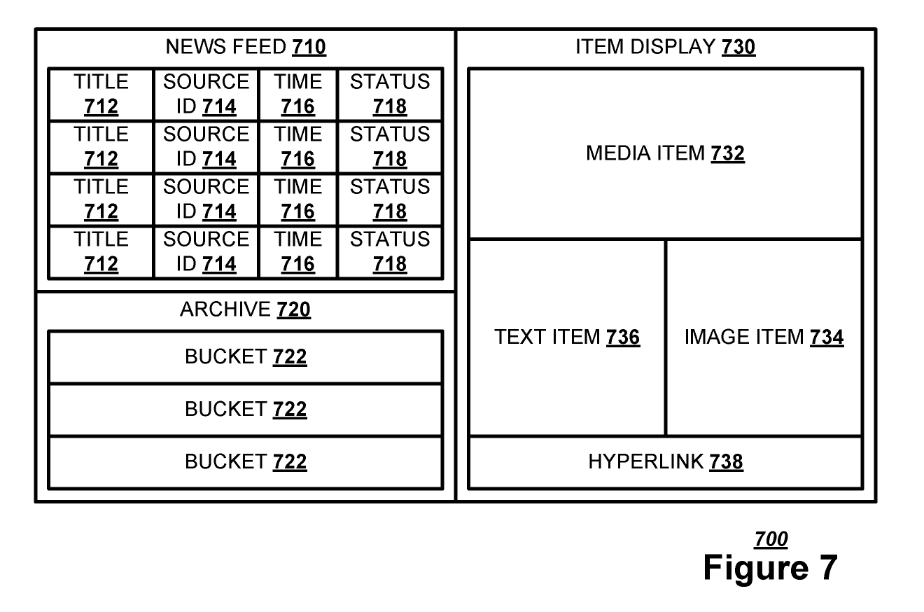

Once the news feed has been generated, the news reader may display the news feed to the worker. FIG. 7 illustrates, in a block diagram, one example of a user interface 700 for a news reader. The user interface may have a news feed 710 listing the news item within the most recent period. The news feed 710 may have a news item title 712 describing the news item. The new feed 710 may have a source identifier 714 indicating the news source that published the news item. The news feed 710 may have a timestamp 716 indicating the time the news item was published to the enterprise news service. The news feed 710 may have a status field 718 that indicates the enterprise relationship between the worker and the news source. The user interface may have a news item archive 720 for news item that predate the most recent period. The news item archive 720 may divide the archive news items into buckets 722 grouping news items from a previous period.

If a worker selects a news item in the new feed 710, the user interface may present the news item in an item display 730. The news item may be a media item 732, an image item 734, or a text item 736. A media item 732 may be an audio or video media item 732. The news item may include a hyperlink 738 to an exterior news source.

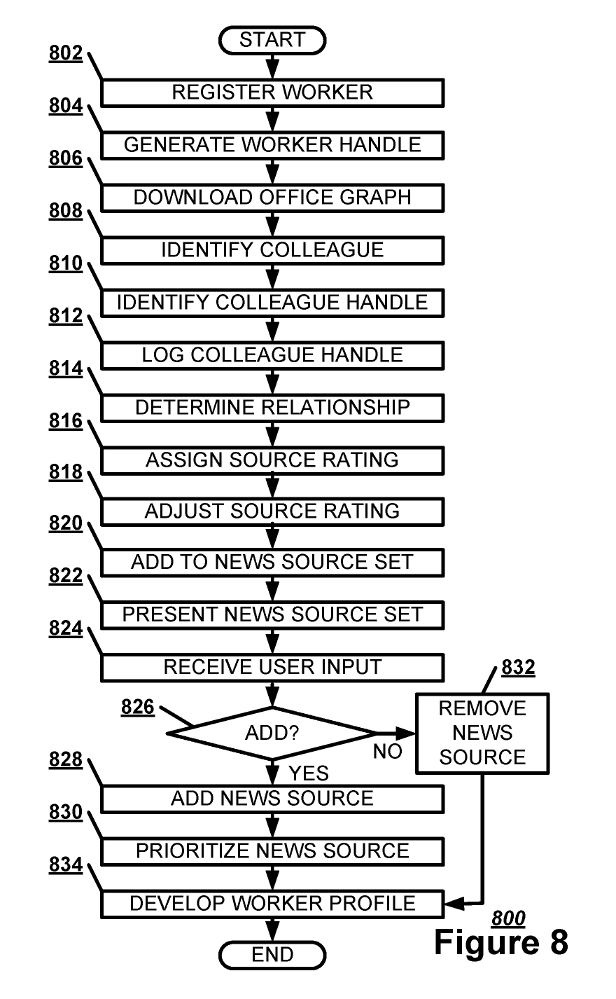

FIG. 8 illustrates, in a flowchart, one example of a method 800 for creating a news source set with an enterprise news service. The enterprise news service may register a worker request to add the worker to the enterprise news system (Block 802). The enterprise news service may generate a worker handle to represent the worker in the enterprise news system (Block 804). The enterprise news service may download an office graph depicting a corporate hierarchy and enterprise relationships from a corporate administration server (Block 806).

The enterprise news service may identify a colleague having a relevant enterprise relationship with the worker from the office graph (Block 808). The enterprise news service may identify a colleague handle representing the colleague in the enterprise news system (Block 810). The enterprise news service may log the colleague handle in the user profile for the worker (Block 812). The enterprise news service may determine an enterprise relationship describing a relationship within an enterprise between the worker and the colleague, such as a manager, a collaborator, or a collaborator manager (Block 814). The enterprise news service may assign a source rating to the colleague based on the enterprise relationship (Block 816). The enterprise news service may adjust a source rating for a collaborator manager based on the number of collaborators reporting to the manager (Block 818). The enterprise news service may add the colleague handle identifying the colleague to a news source set based on the enterprise relationship (Block 820).

The enterprise news service may present the news source set to the worker (Block 822). The enterprise news service may receive a user input from the worker editing the news source set (Block 824). If the user input adds a news source (Block 826), the enterprise news service may add the news source to the news source set based on the user input (Block 828). The enterprise news service may prioritize a news source explicitly added by the worker (Block 830). If the user input removes a colleague from the news source set (Block 826), the enterprise news service may remove the colleague handle from the news source set based on a user input (Block 832). The enterprise news service may develop a worker profile describing a worker news preference based on the enterprise relationship (Block 834).

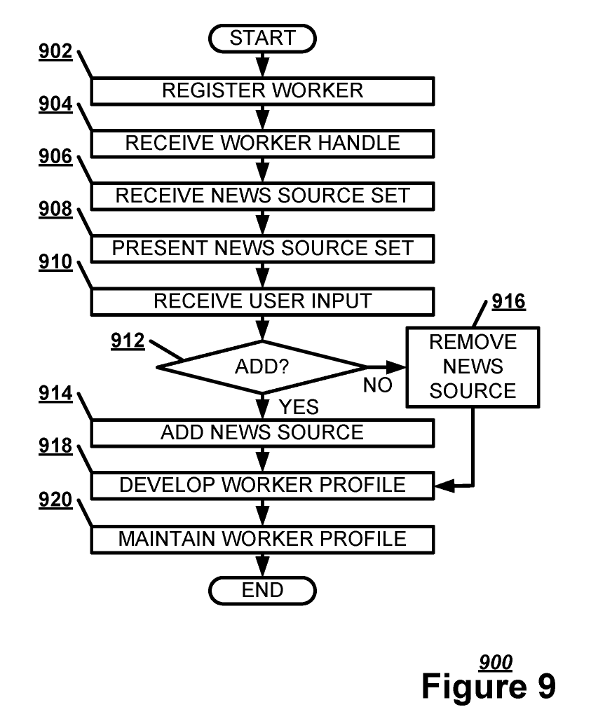

FIG. 9 illustrates, in a flowchart, one example of a method 900 for confirming a news source set with a news reader. The news reader may register a worker with the enterprise news service (Block 902). The news reader may receive a worker handle to represent the worker in the enterprise news system (Block 904). The news reader may receive a news source set for the worker from the enterprise news service (Block 906). The news reader may present the news source set to the worker (Block 908).

The news reader may receive a user input from the worker editing the news source set (Block 910). If the user input adds a news source (Block 912), the news reader may add the news source to the news source set based on the user input (Block 914). If the user input removes a colleague from the news source set (Block 916), the news reader may remove the colleague handle from the news source set based on a user input (Block 916). The news reader may develop a worker profile describing a worker news preference based on the enterprise relationship (Block 918). The news reader may maintain the worker profile at the worker device or the enterprise news service (Block 920).

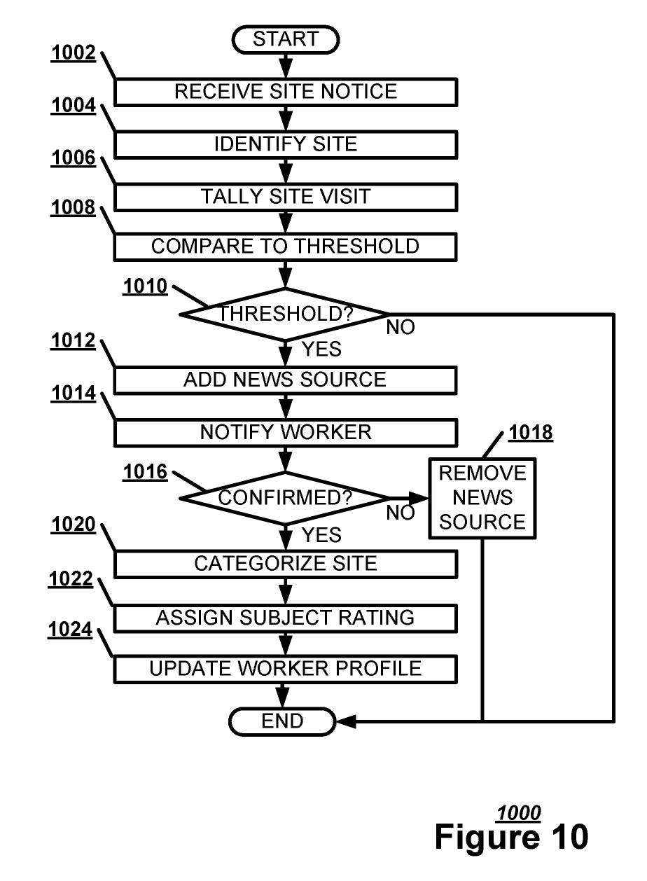

The enterprise news service may update the news source set based upon worker interactions with collaboration sites. FIG. 10 illustrates, in a flowchart, one example of a method 1000 for updating a news source set based on a collaboration site. The enterprise news service may receive a site notice from a collaboration site indicating that a worker has visited the collaboration site (Block 1002). The enterprise news service may identify the collaboration site visited by the worker (Block 1004).

The enterprise news service may tally the visit as an interaction rate for the collaboration site indicating visits by the user to the collaboration site over a recent period (Block 1006). The enterprise news service may compare the interaction rate to a visit threshold for the worker (Block 1008). If the expected interaction rate is greater than the visit threshold (Block 1010), the enterprise news service may add the collaboration site to a news source set for the worker based on a site visit by the worker (Block 1012).

The enterprise news service may notify the worker that the collaboration site has been added to the news source set for the worker (Block 1014). If the worker does not confirm that the collaboration site is to be added to the news source set or confirms that the collaboration site is to be removed from the news source set (Block 1016), the enterprise news service may remove the news source from the news source set (Block 1018). Otherwise, the enterprise news service may categorize a subject matter for the collaboration site (Block 1020). The enterprise news service may assign a subject rating for the collaboration site based on the subject matter and the visit count (Block 1022). The enterprise news service may update a worker profile describing the worker based on the collaboration site (Block 1024).

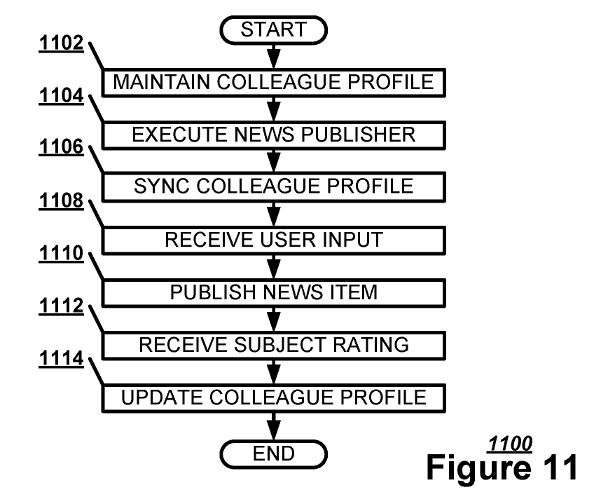

FIG. 11 illustrates, in a flowchart, one example of a method 1100 for publishing a news item from a colleague device. The colleague device may maintain a colleague profile describing the colleague based on the enterprise relationship with the worker (Block 1102). The colleague device may execute a news publisher module to publish a news item to an enterprise news service (Block 1104). The colleague device may synchronize the colleague profile with the instance of the colleague profile maintained at the enterprise news service (Block 1106). The colleague device may receive a user input indicating a news item that the colleague wants published to the enterprise news service (Block 1108). The colleague may generate the news item or may indicate a news item found at an external source, such as a webpage. The colleague device may publish the news item to the enterprise news service (Block 1110). The colleague device may receive a subject rating describing the news item assigned by the enterprise news service (Block 1112). The colleague device may update the colleague profile to reflect the subject rating of the published news item (Block 1114).

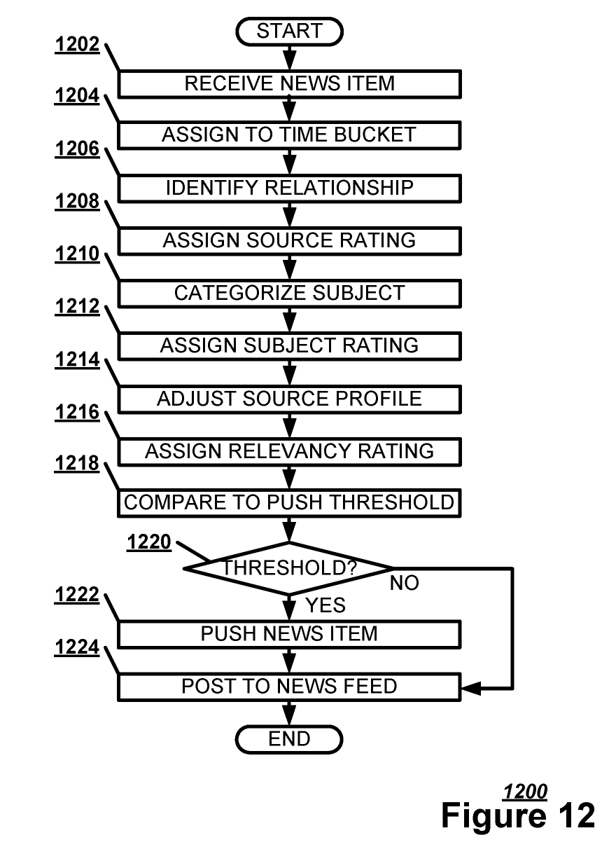

FIG. 12 illustrates, in a flowchart, one example of a method 1200 for receiving a news item at an enterprise news service. The enterprise news service may receive a news item published by a colleague or other news source (Block 1202). The enterprise news service may assign the news item to a time bucket encompassing the time the news item was received (Block 1204). The enterprise news service may identify an enterprise relationship as at least one of a manager, a collaborator or a manager for the collaborator (Block 1206). The enterprise news service may assign a source rating to the news item based on the enterprise relationship of the colleague (Block 1208). For example, a manager for a collaborator may have a greater source rating when managing multiple collaborators of the worker. The enterprise news service may categorize a subject matter of the news item (Block 1210). The enterprise news service may assign a subject rating to the news item based on the subject matter of the news item (Block 1212). The enterprise news service may update a source profile describing interactions between the worker and the news source of the news item based on the subject rating (Block 1214).

The enterprise news service may assign a relevancy rating to the news item as part of a set of news items based on at least one of a source rating and a subject rating (Block 1216). The enterprise news service may compare the relevancy rating of the news item to a push threshold for the worker (Block 1218). If the relevancy rating is above the push threshold (Block 1220), the enterprise news service may push the news item to the worker when the relevancy rating of the new item is greater than the push threshold (Block 1222). The enterprise news service may post the news item to the news feed of the worker based on the enterprise relationship (Block 1224).

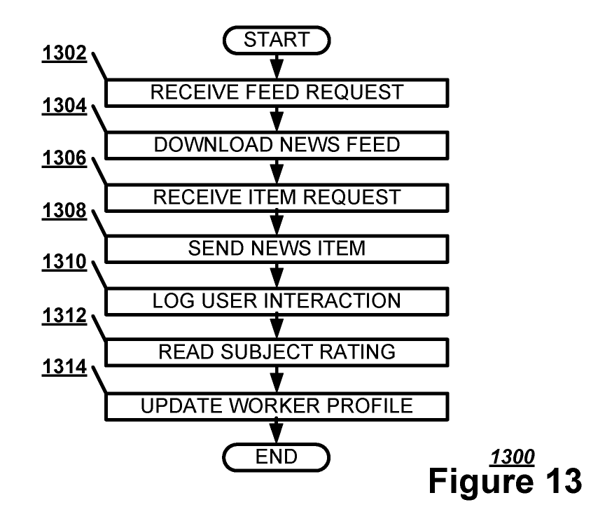

FIG. 13 illustrates, in a flowchart, one example of a method 1300 for sending a news item at an enterprise news service. The enterprise news service may receive from a news reader on a worker device a news feed request asking for an updated news feed for the worker (Block 1302). The enterprise news service may download the current time bucket of the news feed to the news reader (Block 1304). The enterprise news service may receive from the news reader a news item request for the news item in the news feed (Block 1306). The enterprise news service may send the news item indicated in the news item request to the news reader (Block 1308). The enterprise news service may log an interaction with the news item (Block 1310). The enterprise news service may read the subject rating assigned to the news item (Block 1312). The enterprise news service may update a worker profile describing the worker based on the interaction of the worker with the news item (Block 1314).

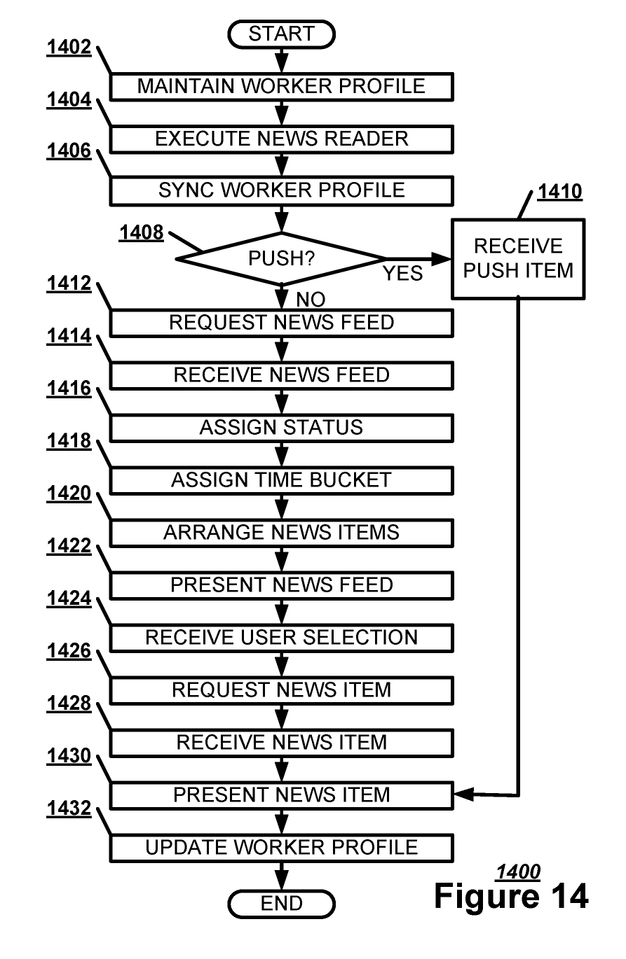

FIG. 14 illustrates, in a flowchart, one example of a method 1400 for receiving a news item in a news reader. A worker device may maintain a worker profile describing a worker news preference based on an enterprise relationship describing a relationship within an enterprise between a worker and a colleague (Block 1402). The worker device may execute a news reader to read news items published at an enterprise news service (Block 1404). The news reader may synchronize the worker profile with an instance of the worker profile maintained at the enterprise news service (Block 1406).

If a news item has a relevancy rating greater than a push threshold for the worker (Block 1408), the news reader may receive the news item having a relevancy rating greater than a push threshold as a push news item without a prior request from the worker (Block 1410). The news reader may request a current news feed for the worker from the enterprise news service (Block 1412). The news reader may receive a current news feed for the worker from the enterprise news service (Block 1414). The news reader may assign a status to news items in the news feed describing the colleagues providing the news items as at least one of a manager, a collaborator, and a collaborator manager (Block 1416). The news reader may assign the news item to a time bucket describing a time period during which the news item was posted (Block 1418). The news reader may arrange a news item set in a time bucket based on a relevancy rating describing relevancy to the worker (Block 1420). For example, the relevancy rating may be based on a combined weighted expected interaction rate with the collaboration site, the colleague writing the news item, and the news subject. The news reader may present the news feed to the worker (Block 1422).

The news reader may receive a user selection from the worker of a news item in the news feed (Block 1424). The news reader may request the news item from the enterprise news service (Block 1426). The news reader may receive from the enterprise news service the news item published by a colleague based on an enterprise relationship, a collaboration site, or other news source (Block 1428). The news reader may present the news item to the worker (Block 1430). The news reader may update the worker profile describing the worker news preference based on an interaction of the worker with the news item (Block 1432).

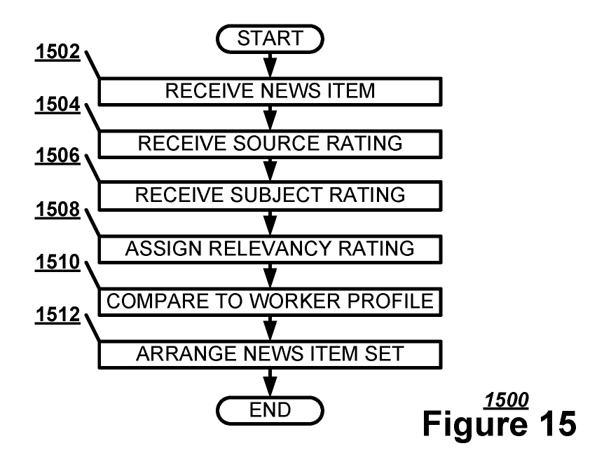

FIG. 15 illustrates, in a flowchart, one example of a method 1500 for arranging a news item in a news feed in a news reader. The news reader may receive the news items in a news feed from an enterprise news service (Block 1502). The news reader may receive from the enterprise news service a source rating to the news item based on the enterprise relationship of the colleague authoring the news item (Block 1504). The news reader may receive from the enterprise news service a subject rating to the news items based on a subject matter of the news item (Block 1506). The news reader may assign a relevancy rating describing relevancy to the worker to the news items based on at least one of a source rating and a subject rating (Block 1508). The news reader may compare a relevancy rating of the news items to a worker profile describing the worker news preference (Block 1510). The news reader may arrange a news item set in a time bucket based on a relevancy rating describing relevancy to the worker (Block 1512).

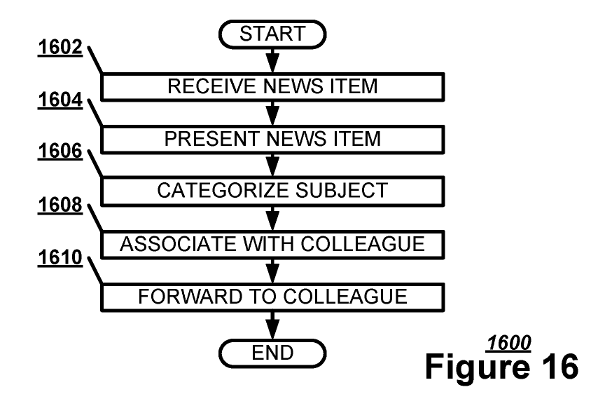

FIG. 16 illustrates, in a flowchart, one example of a method 1600 for processing a news item in a news reader. The news reader may receive a news item from the enterprise news service (Block 1602). The news reader may present the news item to the worker (Block 1604). The news reader may categorize a subject matter for the news item (Block 1606). The news reader may associate the news item with another colleague based on the subject matter or the enterprise relationship with that colleague (Block 1608). The news reader may forward the news item to the other colleague (Block 1610).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Examples within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to store desired program code means in the form of computer-executable instructions or data structures, as opposed to propagating media such as a signal or carrier wave. Computer-readable storage media explicitly does not refer to such propagating media. Combinations of the above should also be included within the scope of the computer-readable storage media.

Examples may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described examples are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. An enterprise news service, comprising:
a processing core having at least one processor configured to determine an enterprise relationship describing a relationship within an enterprise between a worker and a colleague;
memory configured to associate the colleague with a news source set based on the enterprise relationship; and
a communication interface configured to receive a news item from the colleague and post the news item to a news feed of the worker based on the enterprise relationship.

2. The enterprise news service of claim 1, wherein the memory is further configured to identify the enterprise relationship as at least one of a manager, a collaborator, and a collaborator manager.

3. The enterprise news service of claim 1, wherein the processing core is further configured to assign a source rating to the news item based on the enterprise relationship of the colleague.

4. The enterprise news service of claim 1, wherein the processing core is further configured to adjust a source rating for a collaborator manager based on a quantity of collaborators reporting to the collaborator manager.

5. The enterprise news service of claim 1, wherein the processing core is further configured to assign a subject rating to the news item based on a subject matter of the news item.

6. The enterprise news service of claim 1, wherein the processing core is further configured to assign a relevancy rating to a set of news items based on at least one of a source rating and a subject rating.

7. The enterprise news service of claim 1, wherein the communication interface is further configured to push the news item to the worker when a relevancy rating of the new item is greater than a push threshold.

8. The enterprise news service of claim 1, wherein the communication interface is further configured to receive a user input to at least one of remove the colleague from the news source set and add a news source to the news source set.

9. The enterprise news service of claim 1, wherein the communication interface is further configured to receive a visit notification from a collaboration site indicating a visit by the worker.

10. The enterprise news service of claim 1, wherein the memory is further configured to associate a collaboration site with the news source set for the worker based on a site visit by the worker.

11. A computing device, having a memory to store a series of instructions that are executed by at least one processor to implement a news reader, the computing device configured to
maintain a worker profile describing a worker news preference based on an enterprise relationship describing a relationship within an enterprise between a worker and a colleague;
receive from an enterprise news service a news item published by the colleague based on the enterprise relationship; and
present the news item to the worker.

12. The computing device of claim 11, wherein the computing device is further configured to
categorize a subject matter for the news item.

13. The computing device of claim 11, wherein the computing device is further configured to
receive the news item having a relevancy rating greater than a push threshold as a push news item.

14. The computing device of claim 11, wherein the computing device is further configured to
assign the news item to a time bucket describing a time period during which the news item was posted.

15. The computing device of claim 11, wherein the computing device is further configured to
assign a relevancy rating describing relevancy to the worker to the news item based on at least one of a source rating and a subject rating.

16. The computing device of claim 11, wherein the computing device is further configured to
compare a relevancy rating of the news item to the worker profile.

17. The computing device of claim 11, wherein the computing device is further configured to
arrange a news item set in a time bucket based on a relevancy rating describing relevancy to the worker.

18. The computing device of claim 11, wherein the computing device is further configured to
update a worker profile describing the worker news preference based on an interaction of the worker with the news item.

19. A machine-implemented method, comprising:
determining an enterprise relationship describing a relationship within an enterprise between a worker and a colleague;
adding a colleague handle identifying the colleague to a news source set based on the enterprise relationship;
developing a worker profile describing a worker news preference based on the enterprise relationship;
receiving a news item published by the colleague; and
posting the news item to a news feed of the worker based on the enterprise relationship.

20. The method of claim 19, further comprising:
pushing the news item to the worker when a relevancy rating of the new item is greater than a push threshold.
